(19) United States
(12) Patent Application Publication
(10) Pub. No.: US 2025/0246322 A1
(43) Pub. Date: Jul. 31, 2025

(54) Method of and Means for Conversion of X-Ray Energy to Useful Energy in an ICF System

(71) Applicants: Richard B Holmes, Shingle Springs, CA (US); Robert O Hunter, JR., Aspen, CO (US); Eric W Cornell, Colorado Springs, CO (US)

(72) Inventors: Richard B Holmes, Shingle Springs, CA (US); Robert O Hunter, JR., Aspen, CO (US); Eric W Cornell, Colorado Springs, CO (US)

(73) Assignee: Innoven Energy LLC, Solana Beach, CA (US)

(21) Appl. No.: 18/899,516

(22) Filed: Sep. 27, 2024

Related U.S. Application Data
(60) Provisional application No. 63/625,483, filed on Jan. 26, 2024.

(51) Int. Cl. G21B 1/03; G21B 1/11; G21B 1/19; G21D 5/04; H02J 15/00

(52) U.S. Cl. CPC G21B 1/03; G21B 1/115; H02J 15/007

(57) ABSTRACT

In an improved inertial confinement fusion (ICF) system for converting x-ray energy, x-ray radiation from the detonation of an ICF target is directed towards a region containing an inert gas in which the x-ray radiation is absorbed and converted into thermal energy of the atoms of the gas or external coolant fluids. The gas is cooled to a desired temperature by using relatively large amounts of such gas and by absorption of secondary radiation by metal cylinders and heat exchangers. The gas then flows into a series of blowdown turbines to extract energy and is subsequently recycled back into the x-ray region. The electrical power output can be smoothed in time using flywheels. This is done in such a way as to avoid x-ray damage to the containing walls of the x-ray region and to avoid contamination of the target region that would interfere with laser irradiation of the target.

### CROSS-REFERENCE TO RELATED APPLICATIONS

The present application claims priority to provisional patent application No. 63/625,483 filed on Jan. 26, 2024, the entire contents of which are incorporated herein by reference.

### BACKGROUND

R. O. Hunter Jr., D. H. Sowle, C. D. Galloway, A. V. Valys, “High-yield ICF Containment Chambers and Power Reactor,” U.S. Pat. No. 9,287,011 B2 discloses a means for directing x-ray radiation in specific directions from a detonating inertial confinement fusion (ICF) target. A typical high-gain fusion target with a yield of 30 GJ will produce between 15 and 20% of its energy in the form of x-rays and 5 to 7% in debris. Hence the energy in the form of x-ray radiation may be as much as 6 GJ per target, which is the equivalent of almost 1.5 tons of TNT. If such target bursts occur about every 9 seconds as planned for a higher-power system, the time-averaged x-ray energy is about 670 MW, which corresponds to a mid-size power plant. This substantial quantity of x-ray energy would cause severe ablation and vaporization of the debris shield of a target region with a radius up to 4.5 m. A debris shield enduring such erosion would have a limited lifetime, and moreover such ablated material might interfere with laser propagation to the target [1, 2]. On the other hand, such large amounts of energy in the form of x-rays also can be used to create beneficial thermal and electrical energy.

The current state-of-the-art for controlling intense x-ray radiation from the detonation of an ICF target falls into several categories:
a. The use of lead or other metal absorbers (as is well-known in medical x-ray facilities).
b. The use of molten-salt “first-wall” x-ray absorbers, such as Fluorine Lithium Beryllium (FLIBE) [3].
c. The use of magnetohydrodynamics to extract electrical energy directly from the very hot plasma that results from ionization of atoms caused by the intense x-rays [4, 5]. The plasmas are too hot for conventional gas-turbine power systems.
d. Magnetic-field approaches to directly extract electrical energy from the resulting hot plasmas [6, 7].
e. The use of inert gases to absorb x-rays and convert to energy by re-radiation to photovoltaic cells [8].

To choose between these alternatives (and others identified below), there are several considerations. These design considerations include, but are not limited to the following:
f. Protection of the containing walls from x-rays, other ionizing radiation, and high temperatures.
g. Efficient conversion of x-ray energy to electrical energy.
h. Protection of turbines from ionizing radiation, high temperatures, and metal vapors.
i. Low-cost conversion of energy by conventional means if possible.
j. Elimination of exotic or toxic materials if possible.
k. Re-use of the x-ray absorption media from one shot to the next.
l. Reduction of contamination of the target region from all materials but particularly from ionization or ablation of the region's walls.
m. Fit into existing power plants.

Analyses has shown that these objectives can be met by using a significant extension of past approach (e) listed above, using inert gases as the x-ray absorption medium. The hot inert gases will naturally expand and can be used to drive blowdown turbines. Flywheels are used to smooth out the temporal profile of electrical energy production. This novel invention combines various approaches, specifically using some of the above approach (e) with the conversion of some of the x-ray energy to debris energy, and also some collection of thermal energy from walls and optionally inserted metal cylinders.

### SUMMARY

The preferred embodiment described herein comprises a second chamber below the target chamber region as shown. This chamber, referred to as the “x-ray conversion region” (XRCR), is filled with an inert gas or gases. The inert gas or gases absorb nearly all the x-rays directed into the XRCR by the target, so that a negligible fluence of x-rays impinges on the walls and floors of the lower XRCR chamber. Both the outer wall and/or inner perforated walls may be used to further collect heat energy and transfer it to water or another coolant in pipes. The hot inert gases will expand into any open orifices and can be used to drive specific types of blowdown turbines to convert thermal energy into electrical energy at high efficiency. Flywheels, which are large cylindrical objects affixed to the primary axis of a rotating turbine, rotate with the turbines and are used to smooth out the temporal profile of electrical energy production between target detonations. The lower chamber will also receive some debris from the upper chamber. The upper chamber will be referred to as the “target region.” The debris in the target region can be cleared out on a scheduled basis as it accumulates on the floor of the XRCR. Aero-windows are present at the bottom of the target region which evacuates debris from the target region and also pulls in gas from the XRCR which then aids in protection of the floor of the target region from x-rays. The aero-window turbines are protected from the hot debris by cooling and precipitation of the debris as it passes through specific types of pipes that carry the debris from the target region to the turbines.

### BRIEF DESCRIPTION OF THE DRAWINGS

The features of the present invention which are believed to be novel are set forth. The drawings may not be to scale. The invention may best be understood by reference to the following description taken in conjunction with the accompanying drawings, and in which:

FIG. 1 is a cross-sectional side view of one embodiment of a cylindrical fusion energy converter.

FIG. 2A plots a contour diagram of a fraction of x-ray energy remaining in the target versus a fraction of x-ray radiation not redirected and versus excess mass.

FIG. 2B plots the temperature of the x-ray radiation versus case thickness for a given fractional x-ray radiation not redirected.

FIG. 3 is a cross-sectional side view of one embodiment of a cylindrical fusion x-ray energy converter region with blowdown turbines.

FIG. 4 is a cross-sectional side view of one embodiment of an enhanced cylindrical fusion x-ray energy converter region with an internal metal structure.

### DETAILED DESCRIPTION

The term “approximately”, “about”, “near”, “roughly” refer to a given value ranging plus/minus 20%. For example, the phrase of “approximately 1 atmosphere” is intended to encompass a range of 0.80 to 1.20 atmospheres.

Blowdown turbine is a type of turbine that is able to convert thermal energy into electrical energy at high efficiency.

Flywheels are defined as large cylindrical objects affixed to the primary axis of a rotating turbine.

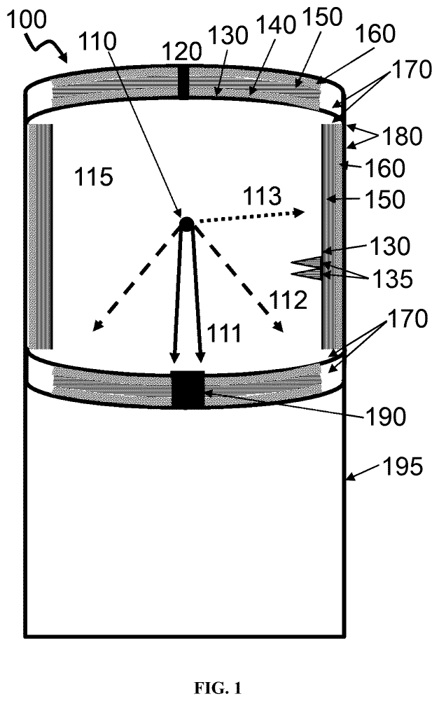

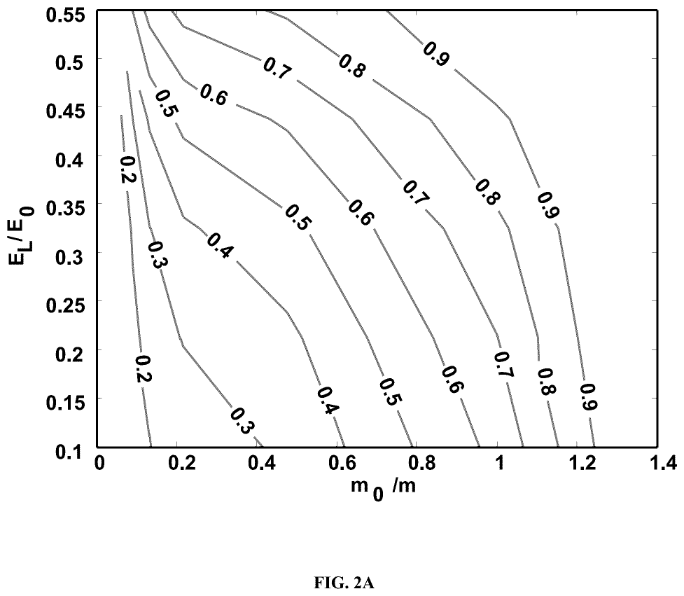

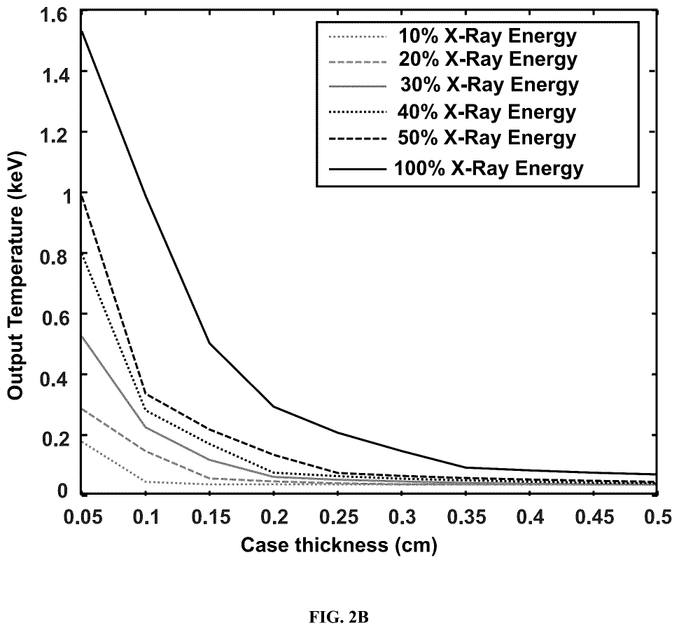

Referring to FIG. 1, cylindrical fusion energy converter 100 contains energy from ignition of a target in the form of directed narrow x-ray radiation 111, broad-angle x-ray radiation 112, and neutrons and debris 113 that are emitted roughly isotropically. The target region 115 may be filled with a gas such as helium, argon, or neon at pressures of 0.001 atm or less in order to aid in reducing the amount of x-ray radiation reaching the walls. In the embodiment considered here, the target 110 is dropped through an orifice 120 at the top of the target region. Once the target reaches the laser aimpoint, the laser, not shown, passes through other orifices, not shown, to ignite the target. The target emits energy approximately isotropically, in the absence of any special treatment of the case. However, in accordance with FIG. 2A and FIG. 2B (further described below), the case may be manufactured to direct up to 90% of the x-ray radiation 111 in an angular cone with a full central angle of about 10 degrees. The neutrons, which have about 75% of the target energy, pass through an inner wall, referred to as a debris shield 130 which protects the outer structures from the impulse due to the target. The outer structures comprise a “hot breeder” 140 in some embodiments, a moderator 150, and a “cool breeder” 160. There are also spaces 170 which serve as manifolds which distribute coolant flows through the breeders and moderators. An enveloping outer converter shell 180 protects the facility from any mishaps which might occur inside the converter. The re-directed x-rays pass through an orifice 190 to an x-ray conversion region 195 which is the primary subject of this invention.

In the preferred embodiment, debris shield 130 is cylindrical and has a diameter that may range from 4 to 12 meters from the cylinder centerline, wherein the larger diameter is used with higher-energy targets. In preferred embodiments, the debris shield consists of 2 to 10 cm of tungsten or 4 to 10 cm of copper backed by steel. Tungsten is a preferred material because it has very high melting and vaporization temperatures and is fairly conductive. Tungsten is also a preferred material because it is known to multiply neutrons, which has the benefit of enhancing the breeding of tritium. Copper is also a preferred material because of its ductility, high thermal conductivity, high specific heat, and lower cost. A Fluorine-Lithium-Beryllium (FLIBE) is not desirable in this approach because of its low-conductivity, its low melting and vaporization temperatures, and its high toxicity.

In some embodiments, a hot breeder 140 of thickness of about 10 cm or less is used to breed tritium and further multiply neutrons. Such a hot breeder breeds tritium from lithium-7in the form of an oxide powder (Li₂O), which has a relatively high breeding cross section for high neutron energies, i.e., energies greater than about 10 MeV. This breeder is called a “hot breeder” because it utilizes high-energy neutrons. This breeding region may also contain beryllium to multiply neutrons at a range of neutron energies. It should also be mentioned that such a hot breeder creates tritium through an endothermic process, absorbing 2.7 MeV of the neutron's energy to split a Li⁷ nucleus into tritium and helium.

In the preferred embodiment, a moderator 150 has a thickness about 50 cm and consists of graphite powder interspersed with coolant tubes along the longitudinal direction of the moderator. The moderator slows the neutrons and therefore absorbs neutron energy. The absorbed energy is transported out of the moderator region by the aforementioned coolant tubes, which are 1 to 3 cm in diameter and comprise steel pipes with internal flowing water.

In the preferred embodiment, the cool breeder 160 lying outside the moderator is about 15 cm thick and comprises lithium-6 in oxide form in a pellet or powder composition. Lithium-6 has very high cross sections for cool neutrons, neutrons with energies less than about 250 keV. This breeder is called a cool breeder because it utilizes low-energy neutrons. It should also be mentioned that such a cool breeder creates tritium through an exothermic process, producing about 4.8 MeV when an Li⁶ nucleus absorbs a neutron and splits into tritium and helium.

The moderator, the blankets, and the inner wall will transfer their heat energy to a coolant such as water. Such water will require a manifold 170 to distribute and gather water within these subsystems. The manifold is located within an outer containment structure 180 which is about 10 cm thick. Thick containment structures are not needed in this design because the target detonations are well-contained by the debris shield. Also, if there is a mishap, the energy production can be stopped merely by aborting the laser (not shown) or the target drop, so a thick containment vessel is not needed for this reason as well.

The orifice 190 to the XRCR is set to match a 10-degree expansion angle for most of the x-ray radiation 111 emanating from the target. So, for a target region 115 that is 10 meters in height, with a target detonation in the middle, the required orifice diameter is about ( 10/2 m) (2*tan( 10/2 degrees))=0.89 meters. The orifice leads into the XRCR chamber 195. There is also some wide-angle, x-ray emission 112 from the target 110. That energy in the wide-angle x-ray emission can be controlled by adjusting the casing mass. The tradeoff between narrow-angle and wide-angle x-ray radiation is summarized in FIG. 2A and FIG. 2B.

FIG. 2A shows a contour diagram of the fraction of residual x-ray energy radiated into the target region versus the fraction of x-ray radiation not redirected into the XRCR and the ratio of nominal case mass to adjusted case mass. FIG. 2B shows the temperature of the x-ray radiation versus case thickness and fractional x-ray radiation not redirected. In FIG. 2A, for example, for a case mass that is 1.6 times that of the nominal case mass (m₀/m=0.6), and with 15% of the x-ray energy not redirected (85% redirected), it can be seen that the fraction of the 15% radiation that is actually radiated into the target chamber is about (0.4)(0.15)=0.06 or 6% of the nominal total radiation emitted. For a preferred class of targets, the nominal total x-ray radiation emitted is about 20% of the total energy, so that the fraction of x-ray energy emitted into the target region compared to the total energy is about (0.06)(0.20)=1.2%, which is relatively quite small. In FIG. 2B, for example, for a case thickness of 0.15 cm (1.5 times the nominal thickness and mass) and with 20% of the x-ray energy not redirected, it can be seen that the x-ray temperature is about 50 eV, which is relatively low compared to the result with no redirection.

Additional beneficial degrees of freedom in the design of the target region 115 include (a) the use of a low-density helium, neon, or argon gas, and (b) a plurality of pyramidal structures 135 that partially or fully cover the inner wall of the debris shield 130. These pyramidal or ridged structures may cover portions of or the entire inner wall. A pyramidal structure and a ridge structure may have similar surface areas with a similar peak-to-peak spacing, but one structure may be easier to fabricate than the other or may be more durable in the presence of repeated fusion detonations. In order to ensure that the laser arrives at the target without breakdown of the intervening gas, the gas should have a density of no more than 10⁻³ atm at room temperature. The gas provides some absorption, energy downshifting, and temporal spreading of the x-rays before said x-rays reach the first wall. A very small amount of argon or neon can provide significant absorption. The use of pyramidal structures on the inner wall of the debris shield adds both additional mass and additional surface area to the debris shield 130. The additional mass of these pyramidal structures 135 is advantageous because it reduces the volume-averaged temperature rise in the shield and the additional surface area allows greater total conduction of thermal energy out of the gas and into the body of the shield.

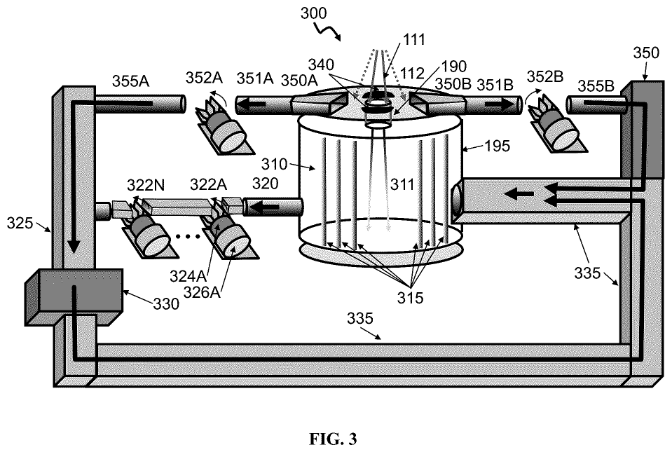

FIG. 1 and FIG. 2A, and FIG. 2B show methods for and means of reducing the x-ray radiation in the target region in order to enable greater conversion of x-ray energy without damage to the containment structure. The radiation that is then redirected away from the containment wall of the target region will primarily be directed to the XRCR but also partially to the floor of the target region. FIG. 3 shows a means 300 to convert both these categories of x-rays to thermal energy.

FIG. 3 shows incident narrow-angle x-ray radiation 111 and also wide-angle x-ray radiation 112 that is directed downwards by means of thinning of the target case as described above. The narrow-angle radiation 111 enters the x-ray conversion region (XRCR) 195, which is filled with one or more inert gases 310. Such preferred gases include argon, helium, neon and N₂. In the preferred embodiment, the number of atoms initially in the XRCR is chosen to be proportional to the total x-ray energy E that enters. So, for example, if 7 GJ of x-ray energy E enters the XRCR, then to obtain a spatially-averaged temperature rise ΔT of about 3000° C. in equilibrium, the number of atoms Nₐₜₒₘ of gas is chosen to be about (γ−1)E/(k_{B}T)=4.2×10²⁸ atoms, where k_{B} is the Boltzmann constant and γ=1.25 is the ratio of specific heats for a partially ionized gas. This corresponds to about N_{g}=7×10⁴ moles of gas. The corresponding mass is about 2800 kg for argon and 280 kg for helium. A preferred embodiment of the XRCR is a cylinder with an inner radius R of 4.5 meters and a height H of 8 meters, leading to a volume V equal to πR²H=509 m³. The gas energy density e is then E/V=(7×10⁹ J)/(509 m³)=1.38×10⁷ J/m³. The corresponding pressure in the XRCR is then (γ−1)e=3.45×10⁶ J/m³˜34 atm. This temperature and pressure will gradually decline due to conduction of heat into the walls which are in turn cooled by coolant pipes 315 that surround the XRCR. The water-filled coolant pipes 315 have a diameter of about 3 cm in the preferred embodiment. The temperature and pressure of the gas will rapidly decline as the hot gas flows out through the exit tube 320. The exiting hot gas will transfer heat to exit tube 320, which also may be surrounded by coolant pipes. Said tube may be of sufficient length that the gas will cool by about a factor about 50%, corresponding to a gas temperature of about 1500 C. At this temperature, the turbine blades will have acceptable lifetimes. The gas flows past the first set of blowdown turbine blades 322A, which are of a buried paddle-wheel design in a preferred embodiment, in order to minimize exposed surface area to prevent excessive impulsive force. The buried paddle-wheel design is a paddle wheel design in which the blades are only partially exposed to the flow. This design is tolerant of the rapid pulses of hot gas that occur in a pulsed ICF system. There are a plurality of blowdown turbines, possibly as many as N=6 of such turbines 322A to 322N in series which convert the thermal energy of the hot gas to electrical energy. The potential conversion efficiency of this arrangement is limited by the Carnot efficiency 1−Tₒᵤₜ/Tᵢₙ, where Tₒᵤₜ is the output temperature and Tᵢₙ is the input temperature, ˜1800 degrees Kelvin. A reasonable output temperature might be about 500 degrees Kelvin, so the limiting efficiency is about 72% for conversion of heat energy into useful work. The hot gas will cool as the gas expands into the pipe. It is estimated that the hot gas in the XRCR will cool to about 500 degrees Kelvin in about 3 seconds, based on adiabatic expansion of the hot gas into a pipe with a diameter of about 60 cm. The flow is always transonic. The rotating turbine 322A is attached to generators 324A to convert rotational energy into electrical energy, and also a flywheel 326A to store the rotational energy and smooth out the energy conversion until the next pulse arrives. There are similar generators and flywheels for the other turbines as well. The next pulse arrives in about 10 seconds after the previous pulse in a preferred embodiment.

The cooled gas will then exit into a duct 325 that will undergo material separation in a separation facility 330 as needed, to separate out gases such as tritium and excess helium. The duct will then pass the nominal gas mixture back to an inlet duct 335 that leads into the XRCR chamber 195. The XRCR chamber walls consist of a steel wall that is about 20 cm thick that is internally coated with about 5 mm of tungsten in a preferred embodiment. The tungsten coating provides the heat resistance that ensures wall survivability.

The flow rate of the gas into the XRCR at inlet 335 is such that the chamber refills to the original gas density by the time the next target ignition occurs. The required average volume flow rate is therefore at most F=(509 m³)/(10 sec)=51 m³/sec since the gas has mostly exited the chamber after blow-down. The required average fluid velocity v in a 60 cm-diameter pipe is about v=F/(π0.6²/4)=180 m/sec. The density ρ of the input gas, consisting primarily of helium, must be about 280 kg/509 m³=0.55 kg/m³, when the chamber is nearly full. Hence the maximum input mass flow rate is about (0.55 kg/m³)(51 m³/sec)=28 kg/sec. This is to be compared with jet engines in commercial aircraft, which have mass flow rates in excess of 300 kg/sec. The stagnation pressure is approximately ρv²/2=0.55×180²/2˜9000 Pa for helium. The pressure of the gas at T_{low}=300 C in the XRCR chamber when full is about R N_{g}T/V=(8.31)(7×10⁴)(300)/509=3.43×10⁵ Pa˜3.4 atm. Here R is the real gas constant, equal to 8.31 J/mole/K. In the preferred embodiment, the gas 310 is mostly helium, but should consist of about 1% argon, neon, or nitrogen by number density to ensure the x-rays are attenuated to about 1 J/cm² at the floor of the XRCR, which is about 8 meters below the entrance hole 190.

The inlet 335 and the outlet 320 may be continuously open or may be shuttered during the period of greatest overpressure in the XRCR. If the inlet and outlet are continuously open, there will be back pressure into the inlet, which can be compensated by higher flow rates or higher pressure in the circulating flow. The blowdown turbines 322A to 322N, must be designed to accommodate this transient overpressure which corresponds to higher torques and lower rotational rates during the interval in the 2 seconds after the x-ray energy is converted to thermal energy.

In addition to the gas flows in the XRCR, there will be gas flows in the target region. These gas flows will consist of target debris, as well as XRCR gas that flows into the target region in the time interval when the shutter 340 is open. The debris gas will consist of small amounts of high-Z material such as tungsten, as well as carbon, deuterium, tritium, and helium. The XRCR gas will consist largely of helium but also other inert gases as well as mentioned above. It is particularly important to (a) separate the tritium to recycle back into fuel, (b) precipitate the tungsten before it gets into turbines where it could reduce turbine lifetime, and (c) cool the gas to a temperature at which the turbines have long lifetimes. It is also very important to ensure that the gas densities are low, of the order of 10⁻³ to 10⁻⁴ atm (and less for higher-Z gases), when the next target is inserted, in order to allow the laser to propagate cleanly to the target without causing gas breakdown. Furthermore, the gases from the XRCR that flow into the lower portion of the target region serve a useful function by attenuating the energy of wide-angle x-ray 112 that does not go through the orifice 190 to the XRCR. This wide-angle x-ray energy may cause rapid erosion of the floor of the target region if not attenuated. Inert gas 310 may be incompletely pumped out of the target region to the aforementioned gas density, 10⁻³ to 10⁻⁴ atm, to aid in attenuation of x-rays while allowing the laser to propagate cleanly to the target.

To maintain a non-zero gas pressure near the floor during target ignition and a near-zero gas pressure near the target in the presence of an open orifice to a region of higher gas pressure, an aero-window approach is employed. In a preferred embodiment, aero-window duct entrances 350A and 350B pull gas from both the region of the orifice and also from the larger target region. More than two ducts may be used. The duct entrances are placed approximately 2 meters from the centerline of the target region and have entrance dimensions of about 40 cm or more high by 2 meters or more wide. The gases pulled into the ducts 351A and 351B are cooled by passage through the ducts, and by mixture of the hot debris gases with cooler gases from the XRCR. Coolant pipes, not shown, on the outside of the ducts 351A and 351B may be used to cool the main pipes and transfer useful thermal energy to turbines. The gases flowing into the ducts then enter turbines 352A and 352B. Prior to target ignition, these turbines do work to pull gases from the target region. Upon target ignition and for roughly 2 seconds thereafter, the hot gases do work on the turbines as said gases exit the target region, providing useful energy.

As with blowdown turbines 322A to 322N, blowdown turbines 352A and 352B are attached to electrical generators and flywheels. The gases pass through the turbines 352A and 352B and then exits via ducts 355A and 355B. These ducts transfer the gases to material separation facilities 330 and 350 where valuable tritium is extracted, along with deuterium and carbon. The heavier components of the target debris, such as tungsten, are deposited in ducts 351A and 351B as mentioned above as the debris gases are cooled and therefore are largely removed from the flow before the gases reach the turbines. Ducts 351A and 351B are removed and replaced regularly to recover the heavy debris components. The flow through said ducts is continuous in the preferred embodiment but will have large peak flows and low minimum flows as specified for a preferred embodiment in the next paragraph.

The specifications for the target region flows are as follows. The flows are most significant when the orifice 190 is open. The shutter 340 is designed to open at about ½ sec before target ignition, to be fully open at target ignition, and to close completely about ½ sec after target ignition. Before target ignition, the XRCR gases 310 are near room temperature, ˜300 degrees K, and at a pressure of about 3.4 atmospheres, as described above. The exit velocity vₑₓ into the target region during this time interval is approximately sonic, which for helium is about 1000 m/sec. During this time interval, the aero-windows must prevent this exiting gas from approaching the target, so the aero-windows must pull this flow into the ducts at this velocity or somewhat more. The cross-sectional area Aₒᵣ of the orifice 190 is about (π/4)0.9² m²=0.64 m². The volume flow rate into the aero-window ducts, F_{AW} is therefore about F_{AW}=VₑₓAₒᵣ=(1000 m/sec)×0.64 m²=640 m³/sec for about ½ second before the target ignites. The density ρ_{XRCR} at this period of time is about (3.4 atm)×(0.004 kg/0.0224 m³/atm)=0.607 kg/m³. This above volume flow rate therefore corresponds to a mass flow rate of about (0.607 kg/m³)×(640 m³/sec)=388 kg/sec. This corresponds to a mas-flow-rate requirement of about 1.2 commercial jet engines for about ½ second and requires external energy, which is large.

After target ignition, the hot debris and XRCR gases will be at much higher pressure and temperature. As stated earlier, the XRCR gas will be at a temperature of about 3000 C and a pressure of about 34 atm in the preferred embodiment. The hot debris will initially be at temperatures in excess of 10,000 degrees C. with a total energy of no more than 2 GJ, including contributions from x-ray radiation in the target region. The gas energy density in the target region just after target ignition is therefore e_{TRO} is (2×10° J)/(502 m³)=4.0×10⁶ J/m³, assuming a cylindrical target region with a radius of 4 m and a height of 10 m. The corresponding pressure in the target region is then (γ−1)e=6.0×10⁵ J/m³˜6 atm, assuming a lower value of γ of about 1.15 at the higher temperature of 10,000 degrees C. or more. Note that this pressure is lower than that computed above for the XRCR after x-ray absorption, which is about 34 atm. Hence the XRCR gas will flow into the target region in the ½ second after the target is ignited but before the shutter 340 is closed. During this time interval after ignition, the incoming helium gas temperature is about 3000 degrees C., so the corresponding sonic velocity is about 3000 m/sec. Therefore, the mass flow rate just after target ignition is expected to initially be about ρvA=(0.607 kg/m³)(3000 m/sec)(0.64 m²)=1170 kg/sec, which quite large. Because the total flow in ½ sec exceeds the mass of XRCR gas of about 280 kg, and because the gas also flows out the outlet and inlet ports during this time as well, a more realistic average gas flow rate out the orifice in this time interval is about 1/10 this amount, or about 120 kg/sec. This is still quite large. A key point here is that the aero-windows have about 10 seconds in this embodiment to pump down the target region, so the required aero-window flow rate after target ignition is closer to 120/10=12 kg/sec, which is a relatively small compared with jet engines in commercial aircraft, which have mass flow rates in excess of 300 kg/sec. It should be noted that the mass of the target is always much less than 100 g in all target designs, so the mass flow rate due to target debris at the aero-windows is much less than that of the XRCR gases due to the open shutter.

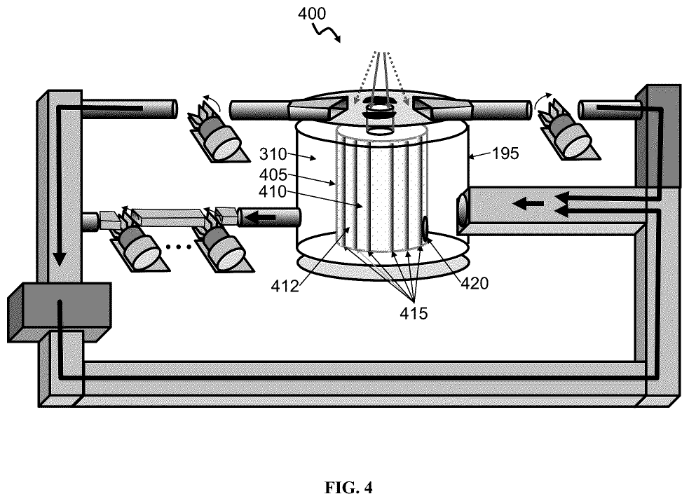

Because the expected gas flow rates at the XRCR orifice are quite high for the aero-window in the embodiment of FIG. 3, another embodiment is considered in FIG. 4. In this embodiment 400, a smaller metal cylinder 405 is filled with a smaller amount of hotter gas 410. The metal cylinder has a radius r_{c} of about 2 meters in a preferred embodiment and a height h_{c} of 8 meters, which is large enough to allow x-rays to diverge unobstructed toward the floor which is 8 meters below the entrance orifice 190 in this embodiment. Said gas may be at a relatively low density and pressure prior to target ignition.

The metal cylinder comprises copper or tungsten or another conductive metal with a thickness of about 3 cm. Small holes 412 about 5 mm or less in diameter, are drilled through the cylinder, with a spacing of about 3 cm. Initially, the smaller amount of hotter gas will be in pressure equilibrium with the denser cooler gas outside the cylinder. The hotter gas 410 is further heated by incident x-rays and then expands through these holes and transfer significant thermal energy to the metal cylinder. This thermal energy is transported off by coolant such as water in pipes 415. The pipes may consist of steel in this embodiment. Said pipes may carry the coolant off to turbines to convert thermal energy to electrical energy. The maximum amount of heat energy that can be carried off by this metal cylinder with an internal surface area of 2πr_{c}h_{c}=101 m² in 10 sec is about 10.1 GJ, assuming a 1 kW/cm² maximum average heat flux into the metal cylinder 405. The gas 410 that is pushed outside the metal cylinder is mixed with the gases 310 of embodiment of FIG. 3 and carried off and processed as described in FIG. 3. The gas 410 is replenished in metal cylinder 405 via an orifice 420, which is plumbed separately to provide a relatively pure stream of this hotter gas to said metal cylinder. The quantity of the gases 310 may be lower in this case because a smaller amount of heat energy resides in the outer gas 310, in this alternate embodiment. In a further extension of this embodiment, the metal cylinder could use pyramidal metal structures on the interior surface to increase the effective surface area by a factor of 2 or more. This could further increase the energy absorbed per target by a factor of 2 or more, resulting in even less energy remaining in the gas.

Advantageously FIG. 4 shows an embodiment having a lower quantity of gas escaping to the XRCR through the orifice 190, which in turn greatly eases the design of the aero-windows. In the case where the density of the gas 410 is about 0.3 atmospheres, which is about 10 times less dense than the surrounding gas 310, and the temperature is 10 times greater, the pressure is then still the same ˜3 atm mentioned above. This lower density of gas 410, if using helium with 1% argon by number density, is still sufficient to absorb the x-ray energy down to the desired residual level of 1 J/cm². In this case, the mass flow rate from the XRCR to the aero-windows is only about 388/10^{1/2}=122 kg/sec rather than 386 kg/sec before target ignition, accounting for both the lower mass density but higher temperature and velocity of the hotter gas 410. This lower mass flow rate from the XRCR to the aero-window considerably eases the aero-window turbine design and still cools the incoming target debris. However, this design has the disadvantage that it utilizes a metal cylinder that is repeatedly subjected to intense heat and pressure, so the metal cylinder 405 may have a limited lifetime. There is also a tradeoff between the absorptive properties of the gas and its radiative characteristics. Varying the composition, density and geometry to optimize the transfer of energy from the x-ray excited region to the metal cooling surface is straightforward.

The benefits of the above embodiment are now summarized. First, the embodiment utilizes the x-ray energy which would otherwise be very destructive, by redirecting most of the x-ray radiation to the XRCR chamber. The XRCR is filled with inert gases that absorb the radiation and then subsequently recover without residual damage. A very small fraction of the target energy is retained in the target region, about 8%, with 7% coming from debris and 1% coming from x-rays. This relatively low amount of energy can be addressed by the means described above. The XRCR uses sufficient inert gas to absorb x-ray energy and equilibrate it to a safe temperature, minimizing wall damage and degradation in the XRCR chamber. The inert gases of the XRCR are kept away from the target region between target ignitions by means of a shutter and aero-window turbines. The gas pressure and temperature in the XRCR is low enough to avoid wall damage. The volume and max dimensions of the XRCR conform with that of the target region. The thermal energy of the hot gas is converted to electricity using blowdown turbines and aero-window turbines with very high theoretical efficiency. The thermal energy in the walls is transferred to water via coolant pipes in the walls which subsequently is used to drive turbines to create electricity. The use of flywheels in conjunction with the turbines spreads out in time the conversion of gas thermal energy to electrical energy. After the gas in the XRCR has expanded, the remaining gas returns to low pressure and relatively low temperature inside the XRCR and inside the debris shield.

The specifications displayed and described herein are examples only, and not intended to limit the general principles of the invention.

1. A system for converting x-ray energy in an Inertial Confinement Fusion (ICF) System, comprising:
an upper cylindrical chamber filled with a gas of no more than 10⁻³ atm at room temperature, structured to receive x-ray radiation from an ICF target located within the upper cylindrical chamber, and which allows direction of the x-ray radiation from the ICF target toward a lower cylindrical chamber;
an inner wall of the upper cylindrical chamber, wherein the inner wall is composed of a thermally conductive material and structured to protect neutron moderation and tritium breeding subsystems from debris and residual x-ray radiation;
the lower cylindrical chamber adjacent to and located beneath the upper cylindrical chamber, wherein the lower cylindrical chamber is filled with one or more inert gases having a distinct number of atoms chosen to be proportional to the total x-ray energy that enters the lower cylindrical chamber;
an orifice leading from the upper cylindrical chamber into the lower cylindrical chamber, wherein the orifice matches a 10-degree expansion angle for the majority of the x-ray radiation received from the ICF target;
a plurality of water-filled coolant pipes surrounding the lower cylindrical chamber;
a gas exit tube to receive the flow of gas from the lower cylindrical chamber;
a plurality of blowdown turbines located within the gas exit tube to convert the thermal energy of the gas to electrical energy, wherein the plurality of blowdown turbines are of a buried paddle-wheel design and to be only partially exposed to the flowing exit gas;
a plurality of generators attached to the plurality of blowdown turbines, wherein the plurality of generators converts rotational energy to electrical energy; and
a plurality of flywheels, attached to the plurality of generators to store the rotational energy and smooth out the energy conversion.

2. The system of claim 1, further comprising:
a plurality of aero-windows located adjacent to the orifice to receive gas from both the orifice and from the ICF target region in the upper cylindrical chamber.

3. The system of claim 2, further comprising:
a plurality of aero-window ducts to cool and precipitate the gas received from the plurality of aero-windows by both a mixture with the cooler gases that have passed through the gas exit tube of the lower cylindrical chamber and conduction of heat into the plurality of aero-window ducts.

4. The system of claim 3, further comprising:
a material separation system to receive the gas from the aero-window ducts and the gas exit tube to extract tritium, deuterium and carbon and to then recycle such gases back into the fuel for the ICF target.

5. The system of claim 4, further comprising:
a metal cylinder centrally positioned inside the lower cylindrical chamber, wherein the metal cylinder is smaller than the lower cylindrical chamber and filled with a gas hotter than that within the lower cylindrical chamber.

6. The system of claim 5, further comprising:
a plurality of holes drilled along the curved surfaces through the metal cylinder; and
a plurality of pipes filled with water, following the length of the metal cylinder,
wherein the hotter gas will disperse through the plurality of holes into the lower cylindrical chamber, transferring a significant amount of thermal energy into the metal cylinder which is then carried off by the plurality of pipes.

7. The system of claim 6, further comprising:
wherein the plurality of pipes, located within the metal cylinder, carry the heated, energy-carrying coolant fluid from the plurality of holes toward a plurality of turbines.

8. The system of claim 7, further comprising:
wherein the gas leaving the plurality of holes from the metal cylinder is replenished and cycled back into the metal cylinder via an opening in the metal cylinder.

9. The system of claim 8, further comprising:
a plurality of metal structures located on the interior surface of the metal cylinder, wherein the plurality of metal structures are pyramid-shaped, which increases the effective surface area by a factor of 2 or more.

10. The system of claim 8, further comprising:
a plurality of metal structures located on the interior surface of the metal cylinder, wherein the plurality of metal structures are ridge-shaped which increases the effective surface area by a factor of 2 or more.

11. The system of claim 1, further comprising:
a plurality of pyramidal structures, wherein the pyramidal structures at least partially cover the inner wall of the upper cylindrical structure and allow for a greater total conduction of thermal energy from the gas and into the inner wall structure.

12. A method for converting x-ray energy in an Inertial Confinement Fusion (ICF) System, comprising:
filling an upper cylindrical chamber with a gas of no more than 10⁻³ atm at room temperature, wherein the upper cylindrical chamber allows direction of the x-ray radiation from the ICF target toward a lower cylindrical chamber;
wherein an inner wall of the upper cylindrical chamber is composed of a thermally conductive material and is structured to protect neutron moderation and tritium breeding subsystems from debris and residual x-ray radiation;
placing the lower cylindrical chamber adjacent to and beneath the upper cylindrical chamber, filling the lower cylindrical chamber with one or more inert gases having a distinct number of atoms chosen to be proportional to the total x-ray energy that enters the lower cylindrical chamber;
creating an orifice leading from the upper cylindrical chamber into the lower cylindrical chamber, wherein the orifice matches a 10-degree expansion angle for the majority of the x-ray radiation received from the ICF target;
surrounding the lower cylindrical chamber with a plurality of water-filled coolant pipes;
receiving the flow of gas from the lower cylindrical chamber to a gas exit tube;
converting the thermal energy of the gas to electrical energy with a plurality of blowdown turbines located within the gas exit tube, wherein the plurality of blowdown turbines are of a buried paddle-wheel design and to be only partially exposed to the flowing exit gas;
converting rotational energy to electrical energy with a plurality of generators attached to the plurality of blowdown turbines; and
storing the rotational energy and smoothing out the energy conversion with a plurality of flywheels, attached to the plurality of generators.

13. The method of claim 12, further comprising:
receiving gas from both the orifice and from the ICF target region in the upper cylindrical chamber to a plurality of aero-windows located adjacent to the orifice.

14. The method of claim 13, further comprising:
cooling and precipitating the gas received from the plurality of aero-windows by both a mixture with the cooler gases that have passed through the gas exit tube of the lower cylindrical chamber and conduction of heat into a plurality of aero-window ducts.

15. The method of claim 14, further comprising:
receiving the gas from the aero-window ducts and the gas exit tube to extract tritium, deuterium and carbon and to then recycle such gases back into the fuel for the ICF target in a material separation system.

16. The method of claim 15, further comprising:
filling a metal cylinder, centrally positioned inside the lower cylindrical chamber, with a gas hotter than that within the lower cylindrical chamber.

17. The method of claim 16, further comprising:
drilling a plurality of holes along the curved surfaces through the metal cylinder; and
filling a plurality of pipes with coolant fluid, following the length of the metal cylinder,
wherein the hotter gas will disperse through the plurality of holes into the lower cylindrical chamber, transferring a significant amount of thermal energy into the metal cylinder which is then carried off by the plurality of pipes.

18. The method of claim 17, further comprising:
carrying the heated, energy-carrying coolant fluid from the plurality of pipes toward a plurality of turbines, wherein the plurality of pipes are located within the metal cylinder.

19. The method of claim 18, further comprising:
replenishing and cycling back the gas leaving the plurality of holes from the metal cylinder into the metal cylinder via an opening in the metal cylinder.

20. The method of claim 19, further comprising:
increasing the effective surface area of the interior surface of the metal cylinder by a factor of 2 or more by placing a plurality of pyramidal metal structures on the interior surface of the metal cylinder.

21. The method of claim 19, further comprising:
increasing the effective surface area of the interior surface of the metal cylinder by a factor of 2 or more by placing a plurality of ridged metal structures on the interior surface of the metal cylinder.

22. The system of claim 12, further comprising:
allowing for a greater total conduction of thermal energy from the gas into the inner wall structure of the upper cylindrical structure by placing a plurality of pyramidal or ridged structures to at least partially cover the inner wall of the upper cylindrical structure.
